(19) United States
(12) Patent Application Publication
(10) Pub. No.: US 2005/0168773 A1
(43) Pub. Date: Aug. 4, 2005

(54) Printing system for predicting printing error through preliminary inspection of printer driver and method thereof

(75) Inventor: Sung-Hoon Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/033,302

(22) Filed: Jan. 12, 2005

(30) Foreign Application Priority Data
Jan. 31, 2004 (KR) 10-2004-0006384

(51) Int. Cl. G06F 3/12; G06F 9/46

(52) U.S. Cl. 358/1.15; 719/321

(57) ABSTRACT

A terminal device that performs printing work using a connected printing device. The terminal device includes a printer driver unit for converting specified data into print data that can be recognized by the printing device when a print command for printing the data is input, and an interface for performing a communication with the printing device. The device further comprises a central processing unit for creating and transmitting driver information about the printer driver unit to the printing device through the interface, and if it is confirmed that the printing device will perform normal printing work, transmitting the print data to the printing device to perform the printing work. Accordingly, the printing device can compare stored data and the received driver information such that a printing malfunction can be predicted in advance, and thus, prevent the waste of user time and resources where printing is impossible.

### CROSS-REFERENCE TO RELATED APPLICATIONS

This application claims the benefit under 35 U.S.C. §119(a) of Korean Patent Application No. 10-2004-0006384 filed in the Korean Intellectual Property Office on Jan. 31, 2004, the entire contents of which are hereby incorporated by reference.

### BACKGROUND OF THE INVENTION

1. Field of the Invention

The present invention relates generally to a printing system and a printing method using the same. More particularly, the present invention relates to a printing system and a printing method thereof, which determines and reports to a user whether a printer can perform a normal printing operation by first transmitting printer driver information prior to a transmission of print data.

2. Description of the Related Art

With the development of computer manufacturing technology, at least one computer has been spread into almost every home. Also, with the spread of computers, peripheral devices for using the computers more conveniently, such as printers, scanners, and the like, have also gradually been spread into these homes. Printers, especially, low-priced printers having diverse performances, have been competitively developed and spread by many manufacturing companies.

A printer is typically connected to a user's terminal device and outputs onto a printing paper any print data transmitted from the user's terminal device. The printer may be classified as a dot printer, inkjet printer, laser printer, and the like, according to its printing type.

The structure of the printer may be divided into an engine part for actually performing a printing work, and a controller part for controlling the engine part. The controller part controls the engine part to perform the printing work according to the received print data when the print data is transmitted from the user's connected terminal device.

The user's terminal device connected to the printer requires a printer driver that can recognize connected hardware, specifically, a printer. For a user to easily use the printer, printer manufacturing companies have developed and provided printer driver programs for converting documents prepared by users into print data using emulations that can be supported by the printers.

FIG. 1 illustrates a general printing system. Referring to FIG. 1, the printing system includes a user's terminal device 10 and a printer 20. The user's terminal device 10 has a printer driver program installed therein for recognizing the printer 20 connected to the terminal device 10. If the user inputs a print command for printing a document prepared using an application program, the printer driver converts the document into the print data using a specified emulation, and then transmits the converted print data to the printer 20 to perform the printing work.

The printer 20 then outputs the print data through the corresponding emulation by searching for a specified address of a header part of the print data or confirming an operation code.

Generally, there is no problem if the printer driver program that is used coincides with the installed printer. However, in the event that a new printer driver is installed due to the served life span of the printer or due to problems occurring in the printer driver program, the printer program may not coincide with the installed printer.

The printer driver programs provided by the manufacturing companies may also not be compatible with one another, and if the printing is performed using the printer driver and the printer which do not coincide with each other, the printing operation may not be performed correctly.

Specifically, if the emulation used by the printer driver and which is installed in the user's terminal device 10 in order to convert the document into the print data, can not be supported by the currently connected printer 20, the printer performs the printing work by analyzing the print data by the emulation that can be supported by the printer. Accordingly, the printer 20 may malfunction and output erroneous data or repeatedly output specified data.

Consequently, the user can recognize the necessity of installing a proper printer driver only after time and effort are wasted attempting to print the document. Accordingly, a need exists for a system and method for analyzing driver information prior to printing, such that printing malfunctions are minimized.

### SUMMARY OF THE INVENTION

The present invention has been developed in order to solve the above drawbacks and other problems associated with the conventional arrangement. An aspect of the present invention is to provide a printing system and a printing method thereof which can predict whether a printing error will occur by first transmitting data including printer driver information and so on, prior to a transmission of print data.

The foregoing and other aspects and advantages are substantially realized by providing a terminal device for performing printing work using a connected printing device, wherein the terminal device comprises a printer driver unit for converting specified data into print data that can be recognized by the printing device if a print command for printing the data is input, and an interface for performing a communication with the printing device. The terminal device further comprises a central processing unit for creating and transmitting driver information about the printer driver unit to the printing device through the interface, and if it is confirmed that the printing device will perform a normal printing work, transmitting the print data to the printing device to perform the printing work.

The interface of the terminal device may receive a specified error message from the printing device that has received the driver information reporting that the normal printing work is impossible. In this case, the terminal device may further comprise a display device for displaying on its screen a specified warning message reporting that a printer driver suitable for the printer should be installed if such an error message is received from the printing device.

The driver information sent to the printing device may include information about at least one of an emulation language that can be supported by the printer driver unit and a model name of the printer.

In another aspect of the present invention, a printing device is provided and can be connected to a user's terminal device for performing a printing work. The printing device comprises a data transceiving unit for receiving driver information about a printer driver installed in the user's terminal device, and a memory for storing information about usable printer drivers. The printing device further comprises a control unit for comparing the driver information with the information stored in the memory when the driver information is received, and if the driver information does not coincide with the information stored in the memory, controlling the data transceiving unit to transmit a specified error message to the user's terminal device.

In this case, the information stored in the memory may include information about at least one of an emulation language that can be supported by the printing device and a model name of the printing device.

In still another aspect of the present invention, a printing method is provided in a printing system including a user's terminal device and a printing device connected to the user's terminal device, for performing a printing work. The printing method comprises the steps of (a) creating and transmitting from the user's terminal device driver information about a printer driver installed therein to the printing device if a print command is input, (b) determining by the printing device whether normal printing work is possible by comparing information stored in a built-in memory with the driver information, (c) transmitting from the printing device a specified error message if it is determined that the normal printing work is impossible, and (d) displaying on a display screen at the user's terminal device a specified warning message reporting that an printing error may occur if the error message is received.

The printing method may further comprise the step of the performing the printing work at the printing device if it is determined that normal printing work is possible.

At step (a), the driver information may created to include at least one of an emulation language that can be supported by the printer driver and a model number of the printing device. Also, it is preferable that step (b) comprises the sub-steps of comparing the emulation information stored in the printing device and the model number of the printing device with the driver information, and determining that normal printing work is impossible if the driver information does not coincide with the stored information as a result of comparison.

### BRIEF DESCRIPTION OF THE DRAWINGS

The above aspects and features of the present invention will become more apparent by describing certain embodiments of the present invention with reference to the accompanying drawings, in which:

FIG. 1 is a view illustrating a general printing system;

FIG. 2 is a block diagram illustrating a printing system according to an embodiment of the present invention;

FIG. 3 is a flowchart illustrating a printing process performed by the terminal device of the printing system of FIG. 2 according to an embodiment of the present invention; and

FIG. 4 is a flowchart illustrating a printing process performed by the printing device of the printing system of FIG. 2 according to an embodiment of the present invention.

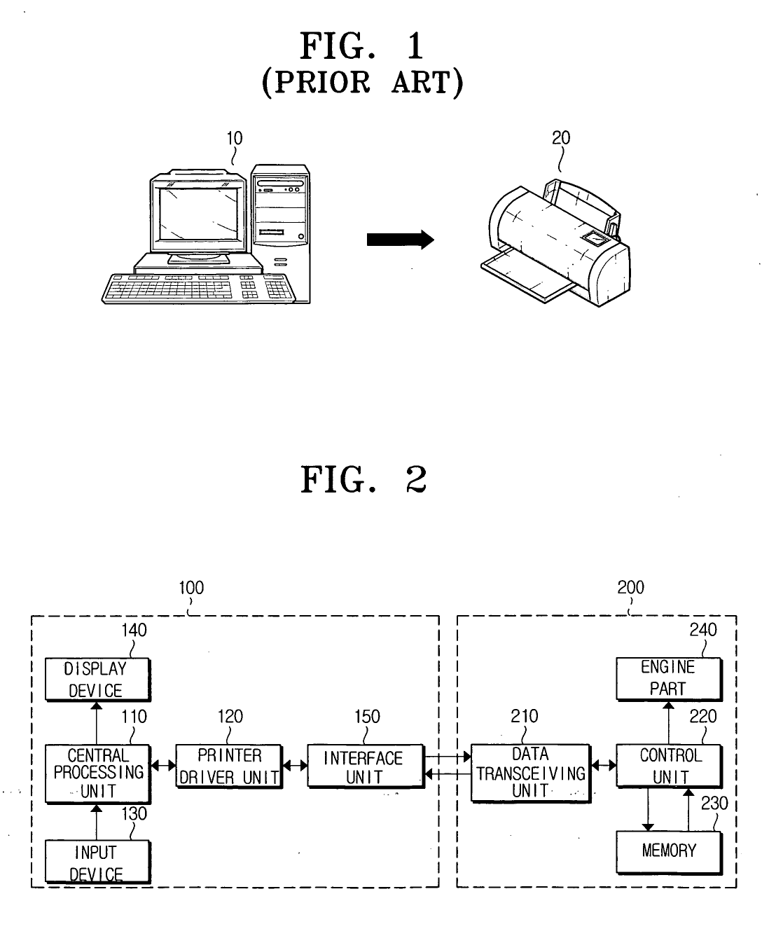

Throughout the drawings, like reference numerals will be understood to refer to like parts, components and structures.

### DETAILED DESCRIPTION OF EXEMPLARY EMBODIMENTS

Certain exemplary embodiments of the present invention will now be described in greater detail with reference to the accompanying drawings. In the following description, same drawing reference numerals are used for the same elements even in different drawings. The matters defined in the description such as a detailed construction and element descriptions are provided to assist in a comprehensive understanding of the invention. Also, well-known functions or constructions are not described in detail since they would obscure the invention in unnecessary detail.

FIG. 2 is a block diagram of a printing system according to an embodiment of the present invention. Referring to FIG. 2, the printing system includes a user's terminal device 100 and a printing device 200. The user's terminal device 100 includes a central processing unit 110, a printer driver unit 120, an input device 130, a display device 140 and an interface unit 150. The printing device 200 includes a data transceiving unit 210, a control unit 220, a memory 230 and an engine part 240.

A user may input a print command through the input device 130 after preparing a document using a specified application installed in the terminal device 100.

The printer driver unit 120 provides that the central processing unit 110 recognizes that the printing device 200 is installed. If the print command is input, the central processing unit 110 controls the printer driver unit 120 to convert the document prepared by the user into print data that can be recognized by the currently installed printing device 200.

In this case, the printer driver unit 120 converts the document into the print data using a specified emulation. The emulation is a language engaged between the user's terminal device 100 and the printing device 200. In order for the control unit 220 of the printing device 200 to properly analyze the data transmitted from the user's terminal device 100, the printer driver unit 120 installed in the user's terminal device 100 converts the document into the print data using a specified emulation.

The emulation for a laser printer is briefly classified into two kinds according to its use, that is, into a PCL (Printer Command Language) emulation and a PDL (Page Description Language) emulation. The PCL emulation is a printer control language developed by HP (Hewlett Packard), and is mainly used for a PC installed in an office. Printer driver versions such as PCL3, PCL4, PCL5, PCL5E, and the like, have been developed and used. The PDL emulation is used for DTP (Desk-Top Publishing). The PDL emulation has diverse fonts in comparison to the PCL emulation, and enables printing of high picture quality to be performed. Currently, the most representative PDL language may be “PostScript” developed by ADOBE.

The printer driver unit 120 can create the print data using the specified emulation. The central processing unit 110 then transmits the print data created by the printer driver unit 120 to the printing device 200 using the interface 150.

In this case, the central processing unit 110, creates and transmits the driver information about the printer driver unit 120 to the printing device 200 before it transmits the print data. The driver information includes information about the emulation (for example, whether to convert to PCL4 or PCL5) used in the printer driver unit 120 as described above, or information about a printer model name and so on, that can be supported by the printer driver program. Since printer driver programs used for printers vary by manufacturing companies, the driver information may further include information about the manufacturing company of the printer driver.

The interface 150 is a path through which data is transmitted between the user's terminal device 100 and the printing device 200, and includes a parallel port, a serial port, and the like. The driver information and the print data are transmitted to the printing device 200 through the interface 150.

If the driver information is received in the data transceiving unit 210 of the printing device 200, the control unit 220 determines whether normal printing work is possible by reading the information stored in the memory 230 and comparing the readout information with the received driver information.

The memory 230 stores emulation information that can be supported by the printing device 200, the model name of the printing device itself, and supportable functions. Accordingly, the control unit 220 compares the emulation information and the model name of the supportable printer included in the received driver information, with the emulation information and the model name stored in the memory 230. If they coincide with each other, the control unit 220 predicts that normal printing work is possible, while if not, the control unit predicts that normal printing work is impossible.

If it is determined that normal printing work is possible, the control unit 220 transmits a signal indicating that the printing is possible to the user's terminal device 100, and the user's terminal device 100 transmits the print data to the printing device 200 through the interface 150. When the print data is received, the control unit 220 of the printing device 200 communicates with the engine part 240 so as to print and output the document according to the print data. The engine part 240 includes mechanical constituent units (not shown) that perform the printing work. In the case of a laser printer, the engine part includes constituent units comprising a photosensitive drum, a charging unit, an LSU (Laser Scanning Unit), a transfer unit, a developing unit, a feeding unit, and a discharge unit.

If it is determined that normal printing work is impossible, the control unit 220 transmits an error message reporting that a printing error may occur to the user's terminal device 100. When the error message is received through the interface 150, the central processing unit 110 of the user's terminal device 100 controls the display device 140 to display a warning message reporting that the printing malfunction may occur. In this case, the central processing unit 110 may also control the display device to display a recommendation message for recommending that the user install a printer driver suitable to the currently installed printer.

The central processing unit 110 may control the display device 140 to display a specified user interface window on the screen (not shown) so that the user can select to continue the printing work even though the user risks some printing malfunction. In the event that the user continues with the printing work, the control unit 220 of the printing device 200 analyzes the print data via the emulation that can be supported by the control unit 220, and controls the engine part 240 to perform the printing work.

If a malfunction is predicted and the user continues with the printing work, the control unit 220 of the printing device 200 may not perform the printing work even if the data is received. That is, if the printing device 200 is not provided with a PostScript chip even though the print data is prepared using the PostScript, that is, the PDL emulation, proper data cannot be output. In this case, the printing work may be compulsorily terminated even if the user attempts to continue the printing work. Otherwise, printing is performed as described in greater detail below.

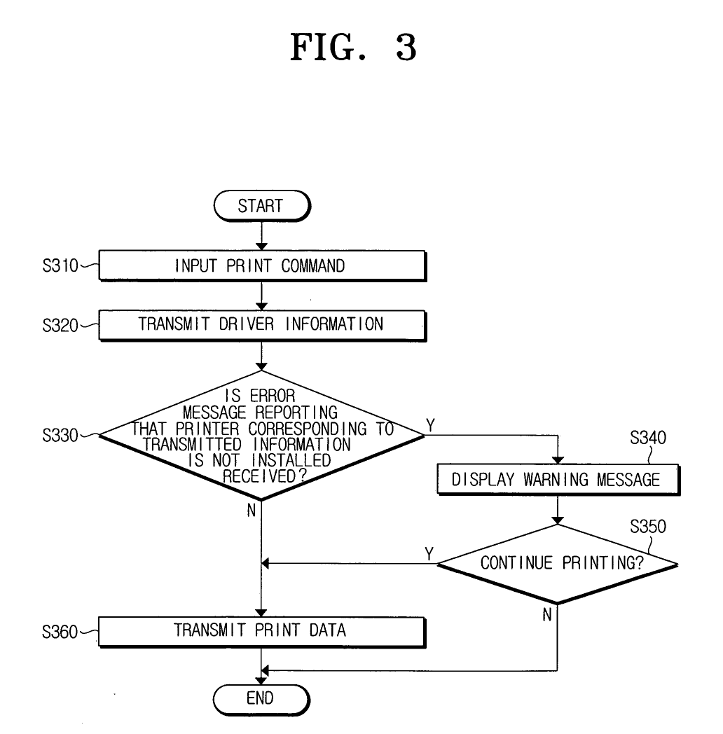

FIG. 3 is a flowchart illustrating a printing process performed by the user's terminal device of the printing system of FIG. 2 according to an embodiment of the present invention. Referring to FIG. 3, if the user inputs the print command at step S310, the central processing unit 110 transmits the information about the printer driver program, that is, information about the printer driver unit 120, to the printing device 200 at step S320.

In this case, the central processing unit 110 determines whether an error message is received from the printing device 200 reporting that it is impossible for the currently installed printer driver program to perform normal printing work at step S330. At this time, if the error message is not received for a specified time or if a message reporting that normal printing work is possible is received, the central processing unit 110 transmits the print data, converted by the printer driver unit 120 using a specified emulation, to the printing device 200 at step S360.

If the error message is received at step S330, the central processing unit 110 may control the display device 140 to display a warning message reporting that a printing malfunction may occur at step S340. It is preferable to display a user interface window for selecting whether to proceed with the printing work, in addition to the display of the warning message. If the user proceeds with the printing work, the terminal device 100 transmits the print data to the printing device 200, while if not, the terminal device terminates the printing process at step S350.

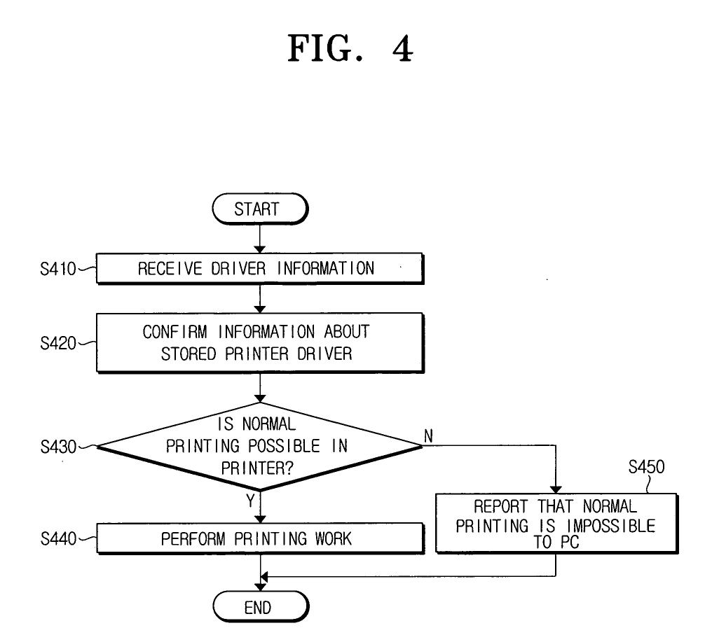

FIG. 4 is a flowchart illustrating a printing process performed by the printing device of the printing system of FIG. 2 according to an embodiment of the present invention. Referring to FIG. 4, the data transceiving unit 210 of the printing device 200 first receives the driver information prior to the reception of the print data at step S410.

The control unit 220 of the printing device 200 determines whether normal printing work is possible at step S430 by confirming the information stored in the memory at step S420. That is, the memory stores information about emulation information that can be supported by the printing device, manufacturing company, model name, and the like, and the control unit 220 compares the emulation information, model name, company name, and the like, included in the received driver information with those stored in the memory. If the information included in the received driver information does not coincide with the information stored in the memory 230 as a result of the comparison, the control unit 220 determines that normal printing work is impossible.

If normal printing is impossible, the control unit 220 prepares and transmits the specified error message to the terminal device 100 through the data transceiving unit 210 at step S450.

However, if normal printing is possible, the control unit 220 receives the subsequently transmitted print data and performs the printing work using the engine part 240 at step S440. In this case, the control unit 220 may first report that normal printing is possible by transmitting the specified message to the terminal device 100.

As described above, according to embodiments of the present invention, whether normal printing work can be performed is first determined prior to the proceeding of the printing work. If a printing malfunction is predicted, a massage for enabling the user to install a proper printer driver and to re-perform the printing work is output to the user. Accordingly, the user is prevented from outputting erroneous data, and thus, preventing wasted time and resources. Also, the respective printer manufacturing company may recommend that the user install the printer driver manufactured by the company in order for the user to use the currently installed printer most efficiently, resulting in additional publicity effects.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A terminal device for performing printing work using a connected printing device, comprising:
a printer driver unit for converting specified data into print data that can be recognized by the printing device when a print command for printing the data is input;
an interface for performing a communication with the printing device; and
a central processing unit for creating and transmitting driver information about the printer driver unit to the printing device through the interface, for receiving a confirmation that the printing device can perform normal printing work, and for transmitting the print data to the printing device to perform the printing work in response to the confirmation.

2. The terminal device as claimed in claim 1, wherein the interface is further provided to receive a specified error message from the printing device that has received the driver information reporting that normal printing work is impossible.

3. The terminal device as claimed in claim 2, further comprising:
a display device for displaying a specified warning message reporting that a suitable printer driver should be installed when the specified error message is received from the printing device.

4. The terminal device as claimed in claim 3, wherein the display device further comprises a display screen.

5. The terminal device as claimed in claim 1, wherein the driver information comprises information about at least one of an emulation language that can be supported by the printer driver unit and a model name of the printer.

6. A printing device connected to a terminal device for performing printing work, comprising:
a data transceiving unit for receiving driver information about a printer driver installed in the terminal device;
a memory for storing information about usable printer drivers; and
a control unit for comparing the received driver information with the information stored in the memory, and for controlling the data transceiving unit to transmit a specified error message to the terminal device if the received driver information does not coincide with the information stored in the memory.

7. The printing device as claimed in claim 6, wherein the memory is further provided to store information about at least one of an emulation language that can be supported by the printing device and a model name of the printing device.

8. A printing method in a printing system including a terminal device and a printing device connected to the terminal device for performing printing work, the printing method comprising the steps of:
(a) creating and transmitting driver information from the terminal device about a printer driver installed therein to the printing device if a print command is input;
(b) determining whether normal printing work is possible by comparing information stored in a printing device memory with the driver information;
(c) transmitting a specified error message from the printing device if it is determined that normal printing work is impossible; and
(d) displaying a specified warning message reporting that a printing error may occur if the error message is received.

9. The printing method as claimed in claim 8, further comprising the step of performing printing work if it is determined that normal printing work is possible.

10. The printing method as claimed in claim 9, wherein the step (a) further comprises the step of:
creating the driver information to comprise information about at least one of an emulation language supported by the printer driver and a model number of the printing device.

11. The printing method as claimed in claim 10, wherein the information stored in the printing device memory comprises information about an emulation language stored in the printing device and the model number of the printing device.

12. The printing method as claimed in claim 11, wherein the step (b) comprises the steps of:
comparing the information about an emulation language stored in the printing device and the model number of the printing device with the driver information; and
determining that normal printing work is impossible if the driver information does not coincide with the information stored in the printing device memory.
